(19) United States
(12) Patent Application Publication
(10) Pub. No.: US 2011/0187828 A1
(43) Pub. Date: Aug. 4, 2011

(54) APPARATUS AND METHOD FOR OBTAINING 3D LOCATION INFORMATION

(75) Inventors: Yu-Hyun KIM, Incheon-si (KR); Jeong-Su PARK, Goyang-si (KR); Tae-Kyeong BAE, Seoul (KR); Man-Hui LEE, Seoul (KR); Jae-Hyun LEE, Bucheon-si (KR); Chang-Shik JUNG, Seoul (KR)

(73) Assignee: PANTECH CO., LTD., Seoul (KR)

(21) Appl. No.: 12/985,192

(22) Filed: Jan. 5, 2011

(30) Foreign Application Priority Data
Jan. 29, 2010 (KR) 10-2010-0008807

(51) Int. Cl. H04N 13/02; G06K 9/00

(52) U.S. Cl. 348/46; 382/154; 348/E13.074

(57) ABSTRACT

An apparatus to obtain 3D location information from an image using a single camera or sensor includes a first table, in which the numbers of pixels are recorded according to the distance of a reference object. Using the prepared first table and a determined focal distance, a second table is generated in which the number of pixels is recorded according to the distance of a target object. Distance information is then calculated according to the detected number of pixels with reference to the second table. A method for obtaining 3D location information includes detecting a number of pixels of a target object from a first image, generating tables including numbers of pixels according to distance, detecting a central pixel and a number of pixels of the target object from a second image, and estimating two-dimensional location information one-dimensional distance of the target object from the tables and pixel information.

### CROSS-REFERENCE TO RELATED APPLICATION

This application claims priority from and the benefit under 35 U.S.C. §119(a) of Korean Patent Application No. 10-2010-0008807, filed on Jan. 29, 2010, which is hereby incorporated by reference for all purposes as if fully set forth herein.

### BACKGROUND

1. Field

The following description relates to an image-based 3D input system.

2. Discussion of the Background

Two or more cameras or sensors are conventionally used to extract three-dimensional (3D) location information. Typically, two cameras are disposed in an orthogonal relation, thereby forming a capturing space. The two cameras simultaneously capture an object in the capturing space producing two images. One of the captured images is used as the input value for the xy plane, and the other is used as a z-axial input value.

As the conventional method for extracting 3D location information uses a plurality of cameras, the entire apparatus becomes bulky and it may be difficult to reduce the size of the apparatus. Further, as every set of data obtained from each camera must be processed, greater volumes of the data must be calculated, resulting in a slower processing speed.

### SUMMARY

Exemplary embodiments of the present invention provide an image-based 3D input system, and a method for obtaining 3D location information.

Additional features of the invention will be set forth in the description which follows, and in part will be apparent from the description, or may be learned by practice of the invention.

Exemplary embodiments of the present invention provide, an image acquirer to obtain an image including a target object, a first table generator to store a first table, in which a number of pixels is recorded according to a distance of a reference object, a pixel detector to detect a central pixel of the target object and a number of pixels of the target object, a second table generator to generate a second table using the first table and the number of pixels of the target object detected at a reference distance, and a location estimator to estimate two-dimensional location information of the target object using the central pixel of the target object, and to estimate a one-dimensional distance of the target object using the number of pixels of the target object and the second table.

Exemplary embodiments of the present invention provide, an image acquirer obtaining an image including a target object, a pixel detector to detect a central pixel of the target object and a number of pixels of the target object from the image, a pixel number corrector to receive size information on a size of the target object and to correct the detected number of pixels using the size information, and a reference table to store numbers of pixels according to a distance of a reference object, and location estimator to estimate two-dimensional location information of the target object using the central pixel, and to estimate a one-dimensional distance of the target object using the corrected number of pixels and the reference table.

Exemplary embodiments of the present invention provide a method for obtaining 3D location information, including, obtaining a first image including a target object at a first distance, detecting a number of first pixels of the target object from the first image, storing a first table comprising numbers of pixels according to a distance of a reference object, generating a second table, corresponding to the first table using the number of first pixels and the first table, obtaining a second image including the target object at a second distance, detecting a central pixel of the target object and a number of second pixels of the target object from the second image, and estimating two-dimensional location information of the target object using the central pixel, and estimating a one-dimensional distance of the target object using the number of second pixels and the second table.

Exemplary embodiments of the present invention provide a method for obtaining 3D location information, including obtaining an image including a target object, detecting a central pixel of the target object and a number of pixels of the target object from the image, receiving size information on a size of the target object and correcting the detected number of pixels using the size information, storing a reference table comprising numbers of pixels according to a distance of a reference object, estimating two-dimensional location information of the target object using the central pixel, and estimating a one-dimensional distance of the target object using the corrected number of pixels and the reference table.

It is to be understood that both foregoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an apparatus to obtain 3D location information according to an exemplary embodiment of the invention.

FIG. 2 is a flow chart illustrating an exemplary method for obtaining 3D location information according to an exemplary embodiment of the invention.

FIG. 3 is a block diagram illustrating an apparatus to obtain 3D location information according to an exemplary embodiment of the invention.

FIG. 4 is a flow chart illustrating a method for obtaining 3D location according to an exemplary embodiment of the invention.

FIG. 5 illustrates a central pixel and the number of pixels in accordance with an exemplary embodiment of the invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience.

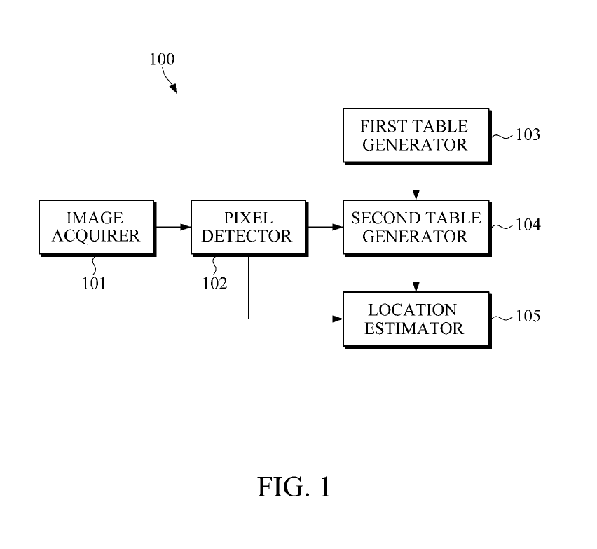

FIG. 1 is a block diagram illustrating an apparatus to obtain 3D location information according to an exemplary embodiment of the invention.

As shown in FIG. 1, the apparatus 100 includes an image acquirer 101, a pixel detector 102, a first table generator 103, a second table generator 104, and a location estimator 105.

The image acquirer 101 obtains an image having a reference or target object. The reference object may be an object having a preset unit size, while the target object may be an object to measure a location.

Further, the image acquirer 101 may include an image sensor array, which senses light and generates an image signal corresponding to the sensed light, and a focus adjusting lens, which allows for the light to be collected on the image sensor array. The image acquirer 101 may be implemented through various sensors, such as a charge coupled device (CCD) optical sensor or a complementary metal oxide semiconductor (CMOS) optical sensor.

The pixel detector 102 detects the central pixel and the number of pixels of the object present in the obtained image. For example, the pixel detector 102 may represent an area where a reference or target object is present in the obtained image by a predetermined tetragon, and detects the center pixel of the tetragon and the corresponding number of pixels located in the tetragon.

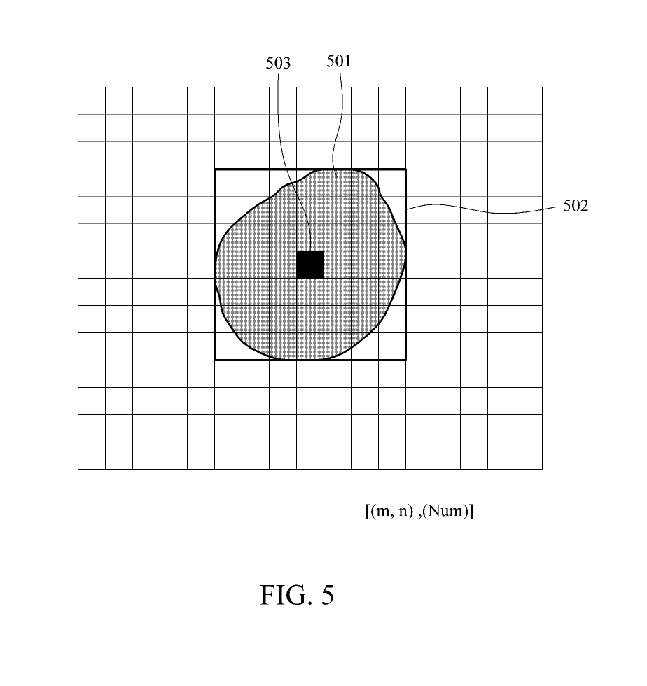

FIG. 5 illustrates a central pixel and the number of pixels in accordance with an exemplary embodiment of the invention.

As shown in FIG. 5, the pixel detector 102 sets a tetragon 502 for an area in which an object 501 is present, and detects coordinates (e.g. m, n) of a pixel 503 corresponding to the center of the tetragon 502 and the number of pixels (e.g. Num) located in the tetragon 502. Both the central pixel and the number of pixels may be dependent on a location and size of the object 501. For example, it can be found that, as the object 501 becomes closer to the apparatus 100, the number of pixels Num increases.

Referring back to FIG. 1, the first table generator 103 has a first table which records the number of pixels according to the distance of the reference object. Here, the distance may be expressed by a distance from the image acquirer 101 to the reference object.

In an example, to generate the first table, the reference object having a unit size (1 cm×1 cm) is placed at a fixed distance, and the image acquirer 101 obtains an image of the reference object. Then, the pixel detector 102 detects the number of pixels of the reference object at the fixed distance, and the first table generator 103 stores the measured distance and the corresponding number of pixels. When this process is repeated with variations in the fixed distance, it is possible to generate a first table with the number of pixels according to the various measured distances. In other words, the first table is adapted to check relationships between the distance and the number of pixels by placing the reference object at a preset distance, recording the number of pixels, and varying the preset distance.

An example of the first table is as follows.

TABLE 1

| Distance | Number of Pixels |
|---|---|
| 5 cm | 10000 |
| 10 cm | 2500 |
| 15 cm | 1560 |
| 20 cm | 625 |
| . . . | . . . |

As shown in Table 1, the distance measured may be determined by the distance between a reference object and an image acquirer 101, and the number of pixels may be that of a tetragon corresponding to an area which a reference object occupies in a captured image.

In an example, the first table stored within first table generator 103 may have been generated prior to the using of apparatus 100, or may be generated using the reference object when used by a user after the procurement of apparatus 100.

Further, multiple first tables may be generated and stored according to the size of the reference object. In an example, if Table 1 above relates to the reference object having the size of 1 cm×1 cm, additional first tables may be generated and stored with reference objects having other sizes, for example 1 cm×2 cm and 2 cm×2 cm.

Second table generator 104 generates a second table corresponding to the first table data according to a number of pixels of a target object detected at various reference distances.

In an example, the reference distance may be defined as a distance between the image acquirer 101 and the target object when the image acquirer 101 moves to be focused on the target object to obtain an image where an automatic focusing function of the image acquirer 101 is inactive. This reference distance may have a fixed value according to a characteristic of the image acquirer 101. More specifically, image acquirer 101 may focus on the target object when the distance between the image acquirer 101 and the target object has met a specific value. This particular distance may be defined as the reference distance.

In another example, the reference distance may be obtained on the basis of a lens correction value or a focal distance correction value of the image acquirer 101. After the target object is placed at an arbitrary position and the automatic focusing function of the image acquirer 101 is activated, image acquirer 101 focuses on the target object using its automatic focusing function to capture its corresponding correction value. Thus, in this manner, reference value may be calculated by utilizing the captured correction value by the automatic focusing functionality.

In an example where the first table such as Table 1 is prepared, it is assumed that the reference distance is 10 cm, and the number of pixels of the target object detected at the reference distance is 3000. Based on the information provided by Table 1, a second table may be generated using proportional relationships found in Table 1. In other words, utilizing the proportional ratio created by number of pixels measured at the specified reference distance, the number of pixels corresponding to a distance other than the reference distance may be calculated through that proportional relationship as shown in Table 2 below.

TABLE 2

| Distance | Number of Pixels |
|---|---|
| 5 cm | 12000 |
| 10 cm | 3000 |
| 15 cm | 1875 |
| 20 cm | 750 |
| . . . | . . . |

Accordingly, referring to Table 2, when the number of pixels is detected at the reference distance, the number of pixels corresponding to a distance other than the reference distance can be calculated using such a proportional relation.

The location estimator 105 estimates a two-dimensional (2D) location of the target object using the central pixel (e.g. 501) of the target object detected by the pixel detector 102. In an example, the 2D location may be x, y coordinates of the central pixel 501 when an image surface is defined as a xy plane and depth direction of the image is defined as a z-axis. Accordingly, the location estimator 105 may use a coordinate value (m, n) of the central pixel 501 of the target object as a coordinate value on the xy plane.

Further, the location estimator 105 estimates a one-dimensional (1D) distance of the target object using the number of pixels detected by the pixel detector 102 and the second table generated by the second table generator 104. In an example, the 1D distance may be a z-coordinate when an image surface is defined as an xy plane and a depth direction of the image is defined as a z-axis. Accordingly, the location estimator 105 may calculate a distance by comparing the number of pixels detected at an arbitrary distance with the values stored in the second table, such as Table 2. Thus, if the detected number of pixels is 2000, the location estimator 105 may estimate the distance of the target object to be about 12 cm with reference to Table 2.

In an example, the image acquirer 101 may be a single image acquirer. In other words, the apparatus 100 may obtain information on a distance from the target object through simple table query without using a stereo camera.

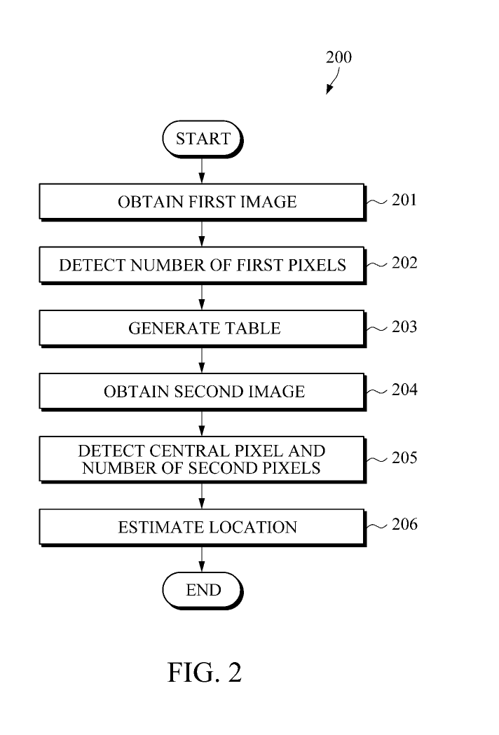

FIG. 2 is a flow chart illustrating an exemplary method for obtaining 3D location information according to an exemplary embodiment of the invention.

As shown in FIG. 2, in the method 200 for obtaining 3D location information, a first image including a target object at a reference distance is obtained (201). In an example, the image acquirer 101 may obtain the image of the target object located at the reference distance. Accordingly, the reference distance may be defined as a distance between the image acquirer 101 and the target object when the image acquirer 101 is arranged to be focused on the target object to obtain the image. This reference distance may be a fixed value according to a characteristic of the image acquirer 101. Further, the reference distance may be calculated based on the characteristic correction value of an automatic focusing function of the image acquirer 101.

In the method 200 for obtaining 3D location information, the number of first pixels of the target object is detected from the obtained first image (202). As shown in FIG. 5, the pixel detector 102 may set a tetragon 502 for an area where the target object of the obtained first image is present, and count the number of pixels occupied by the set tetragon.

Further, in method 200, the number of pixels recorded according to the distance of a reference object is stored in a first table (203). A second table corresponding to a first table is also generated using the number of first pixels of the target object detected at the reference distance. In an example, the second table generator 104 may generate the second table such as Table 2 using the first table (see Table 1) stored in a first table generator 103 and the proportional relationship that is determined between the numbers of pixels of the target objects detected at the reference distances.

As shown in FIG. 2, method 200 obtains a second image of a target object at an arbitrary distance (204). In an example, once the target object located at the reference distance is displaced to a different location, the image acquirer 101 may obtain a secondary image of the target object.

After the second image of the target object is obtained, a central pixel 503 of the target object and its number Num of second pixels are detected (205). As shown in FIG. 5, the pixel detector 102 may set a tetragon 502 for an area where the target object of the obtained second image is present, and count the number Num of pixels occupied by the set tetragon 502.

Lastly, 2D location of the target object is estimated using the detected central pixel, and 1D distance of the target object is estimated using the detected number of second pixels and the generated second table (206). As an example, the location estimator 105 may map coordinates of the detected central pixel 503 to a coordinate value on a xy plane and if the number of second pixels is 2000 and the generated second table is equal to Table 2, location estimator 105 may map a z-coordinate value to about 12 cm.

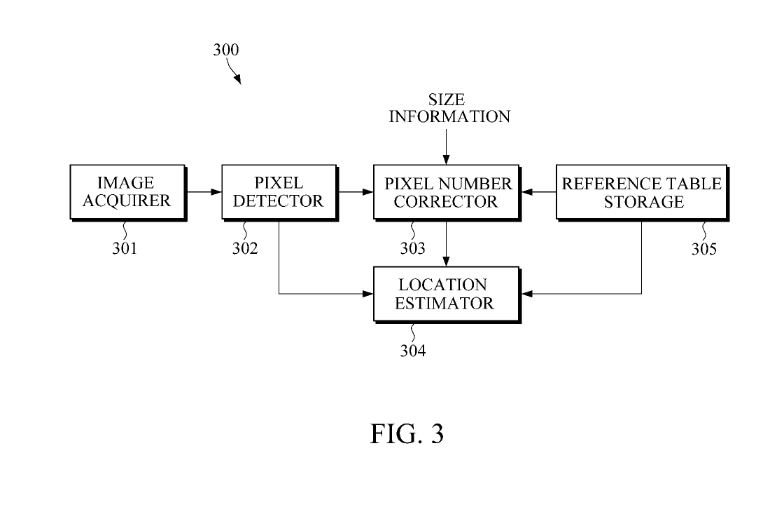

FIG. 3 is a block diagram illustrating an apparatus to obtain 3D location information according to an exemplary embodiment of the invention.

As shown in FIG. 3, the apparatus 300 to obtain 3D location information includes an image acquirer 301, a pixel detector 302, a pixel number corrector 303, and a reference table storage 304.

The image acquirer 301 obtains an image including a target object. Details of the image acquirer 301 are similar to those of the image acquirer 101 of FIG. 1.

The pixel detector 302 detects a central pixel of the target object and its number of pixels from the obtained image. As shown in FIG. 5, the pixel detector 302 detects the central pixel 503 of the target object 501 having coordinates (m, n) and its number of pixels Num from the obtained image.

The pixel number corrector 303 receives information on the size of the target object. The size information of the target object may be a difference in size between the target object and a reference object. Size refers to the surface area of a specific plane of an object (e.g. a plane facing the image acquirer 301). In an example, when the size of the reference object is 1 cm×1 cm, and when the size of the target object is 1 cm×2 cm, the size information of the target object may be 2. The size information of the target object may be inputted by a user. Accordingly, the user may compare the reference object having a unit size with the target object having an apparent size, and calculate instances where the target object is larger or smaller than the reference object, and then input the calculated value as the size information of the target object.

Further, the pixel number corrector 303 may also correct the detected number of pixels using the received size information of the target object. In an example, the pixel number corrector 303 may correct the detected number of pixels so as to be in inverse proportion to the received size information of the target object. Accordingly, when the received size information of the target object is 2 and the detected number of pixels is 2000, the number of pixels may be corrected to be 1000. However, this inverse proportional relation is illustrative for convenience of description, and thus a correction range of the detected number of pixels may depend on a lens characteristic of the image acquirer 301 and a location of the target object within the image.

The location estimator 304 estimates a 2D location of the target object using the central pixel detected by the pixel detector 302. In addition, the location estimator 304 estimates a 1D distance of the target object using the corrected number of pixels and a reference table stored in the reference table storage 305. In an example, the reference table is a table in which the number of pixels is recorded according to a distance of the reference object, and may be represented as in Table 1. Accordingly, when the corrected number of pixels is 1000, the location estimator 304 may calculate the distance of the target object to be about 17 cm with reference to Table 1.

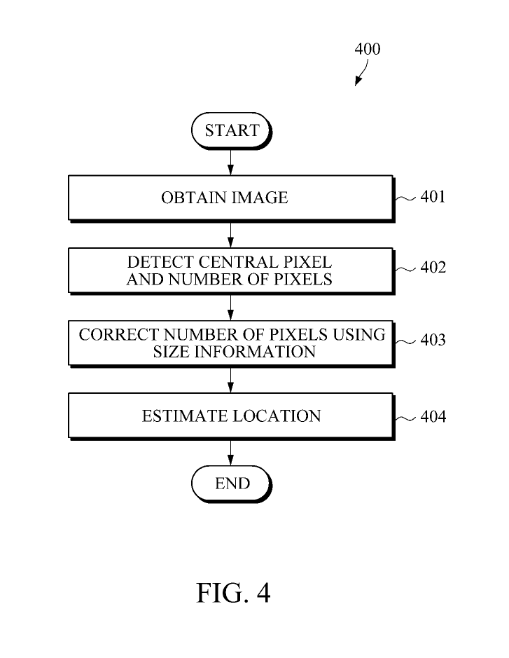

FIG. 4 is a flow chart illustrating a method for obtaining 3D location according to an exemplary embodiment of the invention.

As shown in FIG. 4, in the 3D location estimating method 400, an image including a target object is first obtained (401).

Based on the captured image, a central pixel of the target object and its number of pixels are detected (402).

Subsequently, information on the size of the target object is received from a user, and the detected number of pixels is corrected using the received size information (403). As an example, the pixel number corrector 303 may receive a size difference between the target object and a reference object from a user. Accordingly, detected number of pixels may be corrected on the basis of the received size difference.

Further, 2D location of the target object is estimated using the detected central pixel, and 1D distance of the target object is estimated using the corrected number of pixels and the reference table (404).

A reference table is prepared similarly to Table 1, namely by recording the distances of the reference object and the corresponding number of pixels.

In addition, the distance spaced apart from the reference object may be calculated based on the number of pixels recorded. Accordingly, as the number of pixels of the target object is proportional to that of the reference object, the distance of the target object may be calculated using the corrected number of pixels and the reference table.

The exemplary embodiments can also be embodied as computer-readable codes on a computer-readable recording medium. The computer-readable recording medium is any data storage device that can store data which can be thereafter read by a computer system.

Examples of the computer-readable recording medium include read-only memories (ROMs), random-access memories (RAMs), CD-ROMs, magnetic tapes, floppy disks, and optical data storage devices. The computer-readable transmission medium can transmit carrier waves or signals (e.g., data transmission through the Internet). The computer-readable recording medium can also be distributed over network-connected computer systems so that the computer-readable code is stored and executed in a distributed fashion. Also, functional programs, codes, and code segments to accomplish the present invention can be easily construed by programmers skilled in the art to which the present invention pertains.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to obtain 3D location information, comprising:
an image acquirer to obtain an image including a target object;
a first table generator to store a first table, in which a number of pixels is recorded according to a distance of a reference object;
a pixel detector to detect a central pixel of the target object and a number of pixels of the target object;
a second table generator to generate a second table using the first table and the number of pixels of the target object detected at a reference distance; and
a location estimator to estimate two-dimensional location information of the target object using the central pixel of the target object, and to estimate a one-dimensional distance of the target object using the number of pixels of the target object and the second table.

2. The apparatus of claim 1, wherein a reference object is defined as an object having a preset unit size, and a target object is defined as an object to be measured.

3. The apparatus of claim 1, wherein the reference distance is defined as a distance between the image acquirer and the target object when the image acquirer is focused on the target object.

4. The apparatus of claim 3, wherein the reference distance has a fixed value according to a characteristic of the image acquirer.

5. The apparatus of claim 1, wherein the reference distance is calculated based on a characteristic correction value obtained by an automatic focusing function of the image acquirer.

6. The apparatus of claim 1, wherein the two-dimensional location information is coordinate information of the central pixel of the target object.

7. An apparatus to obtain 3D location information, comprising:
an image acquirer to obtain an image including a target object;
a pixel detector to detect a central pixel of the target object and a number of pixels of the target object from the image;
a pixel number corrector to receive size information on a size of the target object and to correct the detected number of pixels using the size information;
a reference table to store numbers of pixels according to a distance of a reference object; and
a location estimator to estimate two-dimensional location information of the target object using the central pixel, and to estimate a one-dimensional distance of the target object using the corrected number of pixels and the reference table.

8. The apparatus of claim 7, wherein the size information of the target object includes information about a size difference between the reference object and the target object.

9. The apparatus of claim 7, wherein the two-dimensional location information is coordinate information of the central pixel of the target object.

10. A method for obtaining 3D location information, comprising:
obtaining a first image including a target object at a first distance;
detecting a number of first pixels of the target object from the first image;
storing a first table comprising numbers of pixels of according to a distance of a reference object;
generating a second table corresponding to the first table using the number of first pixels and the first table;
obtaining a second image including the target object at a second distance;
detecting a central pixel of the target object and a number of second pixels of the target object from the second image; and
estimating two-dimensional location information of the target object using the central pixel, and estimating a one-dimensional distance of the target object using the number of second pixels and the second table.

11. The method of claim 10, wherein a reference object is defined as an object having a preset unit size, and a target object is defined as an object to be measured.

12. The method of claim 10, wherein the two-dimensional location information is coordinate information of the central pixel of the target object.

13. A method for obtaining 3D location information, comprising:
obtaining an image including a target object;
detecting a central pixel of the target object and a number of pixels of the target object from the image;
receiving size information on a size of the target object and correcting the detected number of pixels using the size information;
storing a reference table comprising numbers of pixels according to a distance of a reference object;
estimating two-dimensional location information of the target object using the central pixel, and estimating a one-dimensional distance of the target object using the corrected number of pixels and the reference table.

14. The method of claim 13, wherein a reference object is defined as an object having a preset unit size, and a target object is defined as an object to be measured.

15. The method of claim 13, wherein the two-dimensional location information is coordinate information of the central pixel of the target object.

16. The method according to claim 13, wherein the size information of the target object includes information about a size difference between the reference object and the target object.
